(19) United States
(12) Patent Application Publication
(10) Pub. No.: US 2005/0166703 A1
(43) Pub. Date: Aug. 4, 2005

(54) Variable rate control pedal

(76) Inventor: Nebojsa Djordjevic, Toronto (CA)

Correspondence Address: Robin W. Asher;Clark Hill PLC, Suite 3500, 500 Woodward Avenue, Detroit, MI, 48226-3435, US

(21) Appl. No.: 11/047,799

(22) Filed: Jan. 31, 2005

Related U.S. Application Data
(60) Provisional application No. 60/540,268, filed on Jan. 29, 2004.

(51) Int. Cl. G05G 1/14

(52) U.S. Cl. 74/512

(57) ABSTRACT

A control pedal assembly includes an eccentric curve as an actuator surface at one end of a pedal arm and a control member includes a first lobe with a roller that rides on the actuator surface and a second lobe that receives a connector rod to a control device to be controlled by the pedal. The eccentric curve changes the stroke ration between the pedal stroke and the connector rod stroke as the pedal is depressed. Designers can simply and efficiently vary the stroke ratio as desired by selecting an appropriate curve for the actuator surface.

### FIELD OF THE INVENTION

The present invention relates to control pedals for vehicles. More specifically, the present invention relates to a control pedal assembly which provides a variable ratio between the pedal stroke and the stroke of the control device operated by the pedal.

### BACKGROUND OF THE INVENTION

Control pedals are employed in vehicles to actuate control devices for a variety of systems including brakes, clutches and accelerators. The control devices can be cables, hydraulic master cylinders or others.

In many circumstances, it is desired and/or required that the ratio between the stroke of the control pedal and the stroke of the control device, the “stroke ratio”, not be constant over the stroke of the pedal. For example, in braking systems it can be desired that for an initial portion of the stroke of the control pedal, the control device be stroked a correspondingly high amount to quickly bring the brake shoes, and/or pads, into engagement with the drums and/or discs. Once the brakes are engaged, it is desired that the stroke ratio be decreased such that further movement of the control pedal strokes the control device to a lesser extent to allow fine control of the now-engaged brakes. Similarly, the force required to operate a control device can be modulated over the stroke of the control pedal by varying the stroke ratio as the activation force required at the control device varies.

Many prior art attempts have been made to provide a control pedal with a stroke ratio that is varied over the length of the pedal stroke. Examples include, U.S. Pat. No. 5,848,558 to Isono et al. and published U.S. patent application Ser. No. 2003/010639s to Willemsen, both of which employ multiple mechanical linkage arms to achieve a stroke geometry that varies the stroke ratio between a control pedal and a control device over the range of the pedal stroke. Such approaches suffer from disadvantages in that they require extra linkage parts, introducing additional friction and/or slack in the control of the system. Further, it can be difficult of impossible to design such systems to achieve some desired stroke ratio profiles.

U.S. Pat. No. 5,214,979 to Crack and U.S. Pat. No. 5,239,891 to Stocker show cable mechanisms which provide a cam mechanism to tension the cable to vary the stroke ratio over the range of the pedal stroke. These systems also suffer from disadvantages in that they only operate for cable-driven control mechanisms and that they require many components. Further, such systems are quite limited in how the stroke ratio can be changed over the stroke of the pedal and, for example, it can be very difficult, if not impossible, to change from an increasing ratio to a decreasing ratio over the pedal stroke.

### SUMMARY OF THE INVENTION

It is an object of the present invention to provide a novel control pedal assembly which can provide a variable stroke ratio between the pedal and the control device and which obviates or mitigates at least one disadvantage of the prior art.

According to a first aspect of the present invention, there is provided a control pedal assembly comprising: a mount to mount the assembly to a vehicle; a pedal arm pivotally attached to the mount, the pedal arm including a first end to receive a foot pedal and a second end including an actuator surface; a control member pivotally attached to the mount and having a first end including a roller to ride on the actuator surface and a second end to receive a connecting rod from a device to be controlled by the assembly; and biasing means to bias the roller into engagement with the actuator surface, wherein the actuator surface is in the form of an eccentric curve to vary the ration between the stroke of the pedal and the stroke of the connector rod over at least a portion of the range of movement of the pedal arm.

According to another aspect of the present invention, there is provided an assembly for a control pedal providing a varying ratio between the stroke of a pedal of the assembly and the stroke of a control device operated by the pedal, comprising: a frame including a mount to mount the assembly to a vehicle; a pedal arm including a first end to receive a control surface and a second end including an actuator surface, the pedal being pivotally attached to the frame intermediate the first and second ends; a control member having a first end including a roller to ride on the actuator surface and a second end to receive a connecting rod from a device to be controlled by the assembly, the control member being pivotally attached to the frame intermediate the first and second ends; and biasing means to bias the roller into engagement with the actuator surface.

### BRIEF DESCRIPTION OF THE DRAWINGS

Preferred embodiments of the present invention will now be described, by way of example only, with reference to the attached Figures, wherein:

FIG. 1 shows a perspective view of a control pedal assembly in accordance with the present invention;

FIG. 2 shows a side view of the control pedal assembly of FIG. 1 with a portion of the side frame of the assembly removed;

FIG. 3 shows a pedal arm, control member and roller of the pedal assembly of FIG. 1 in an at rest position; and

FIG. 4 shows the pedal arm, control member and roller of FIG. 3 in a depressed position.

### DETAILED DESCRIPTION OF THE INVENTION

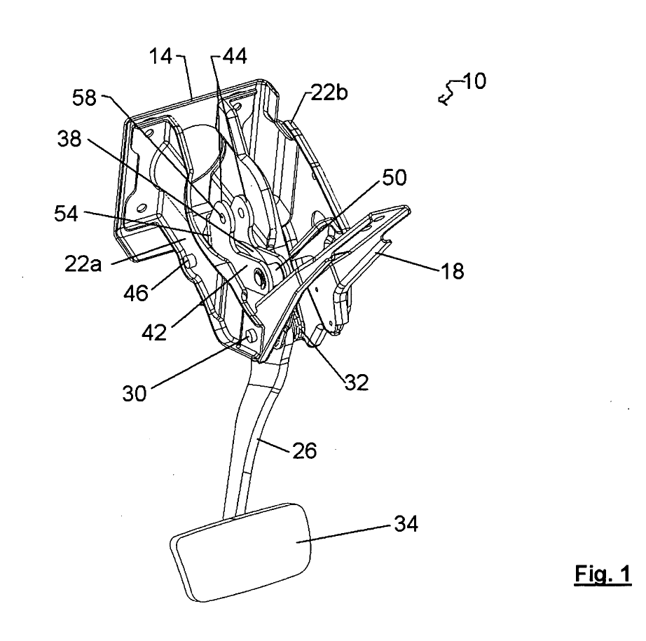

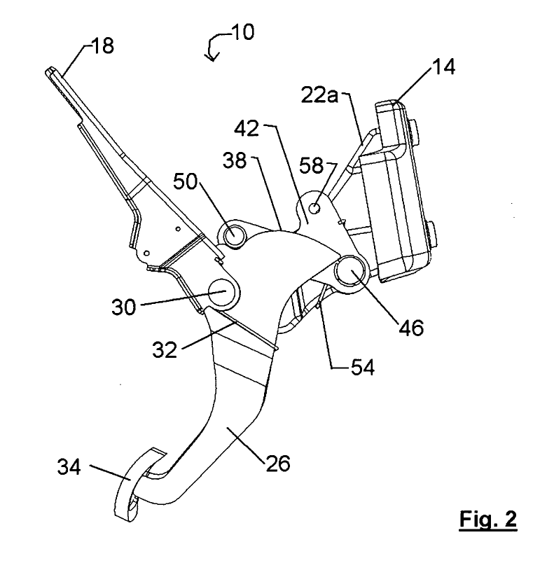

A control pedal assembly in accordance with the present invention is indicated generally at 10 in FIGS. 1 and 2. Assembly 10 includes a mounting frame 14 and a support 18 to attach assembly 10 to a vehicle.

A pair of side frames 22a, 22b extend between mounting frame 14 and support 18 and a pedal arm 26 is connected to assembly 10 by a pivot pin 30 extending between side frames 22a, 22b. A torsion spring 32 acts between pedal arm 26 and support 18 to bias pedal arm 26 to the at rest position illustrated in FIGS. 1 and 2.

Pedal arm 26 includes a lower portion wherein a foot pedal 34 is mounted and an upper portion which includes an actuator surface 38. As illustrated, actuator surface 38 has the form of an eccentric, or changing radius, curve.

A two-lobed control member 42, comprising a pair of spaced plates 44, is also mounted between side frames 22a, 22b and about actuator surface 38 by a pivot pin 46. One lobe of member 42 includes a roller 50 which is mounted between plates 44 and is biased into engagement with actuator surface 38 by a spring 54 that acts between side frames 22a, 22b and control member 42.

The other lobe of control member 42 includes an aperture 58 to receive a connector rod (not shown) from a control device.

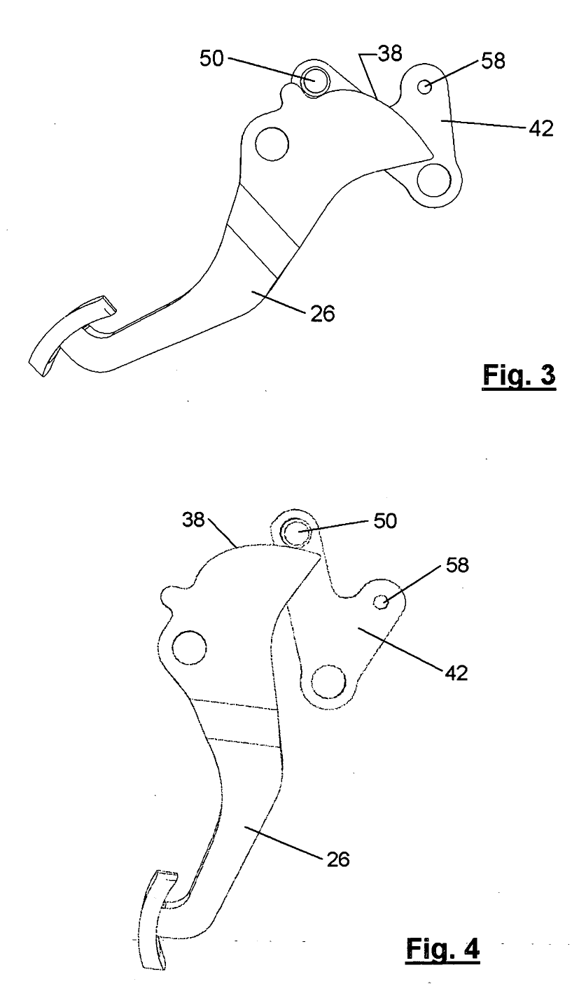

When a vehicle operator depresses foot pedal 34, pedal arm 26 rotates about pivot pin 30, moving actuator surface 38. As actuator surface 38 moves, roller 50 is displaced from the position illustrated in FIG. 2, rotating control member 46 clockwise (when viewed in FIG. 2) and moving aperture 58 toward mount 14. When a connector rod is connected between a control device and aperture 58, the control device will be actuated accordingly. FIGS. 3 and 4 show a portion of assembly 10 in more detail. In FIG. 3, pedal arm 26 and control member 42 are in their at rest positions and in FIG. 4, the vehicle operator has depressed pedal arm 26, moving actuator surface 38 and, in turn, roller 50 to move control member 42 as shown.

When a vehicle operator releases foot pedal 34, pedal arm 26 will return to the illustrated at rest position due to the bias of torsion spring 32 and any force exerted by the control device, and roller 50 will move along actuator surface 38 to return to the position shown in FIG. 2.

As will be apparent, the stroke ratio provided by assembly 10 can be varied as desired by selecting an appropriate curve for actuator surface 38. As used herein, the term “curve” is intended to include a variety of actual shapes, including decreasing radius curves, irregular curves, eccentric and heterogeneous surfaces, etc. which can provide any necessary variation of the stroke ratio of assembly 10. For example, a curve can be employed which increases the stroke ratio over one portion of the pedal stroke and which decreases the ratio over another portion and/or which maintains a constant ratio over another portion. The ability for vehicle designers to easily obtain a desired stroke ratio variation is one of the perceived advantages of the present invention, along with its simplicity and manufacturing cost.

The above-described embodiments of the invention are intended to be examples of the present invention and alterations and modifications may be effected thereto, by those of skill in the art, without departing from the scope of the invention which is defined solely by the claims appended hereto.

1. A control pedal assembly comprising:
a mount to mount the assembly to a vehicle;
a pedal arm pivotally attached to the mount, the pedal arm including a first end to receive a foot pedal and a second end including an actuator surface;
a control member pivotally attached to the mount and having a first end including a roller to ride on the actuator surface and a second end to receive a connecting rod from a device to be controlled by the assembly; and
biasing means to bias the roller into engagement with the actuator surface, wherein the actuator surface is in the form of an eccentric curve to vary the ration between the stroke of the pedal and the stroke of the connector rod over at least a portion of the range of movement of the pedal arm.

2. An assembly for a control pedal providing a varying the stroke ratio between the stroke of a pedal of the assembly and the stroke of a control device operated by the pedal, comprising:
a frame including a mount to mount the assembly to a vehicle;
a pedal arm including a first end to receive a control surface and a second end including an actuator surface, the pedal being pivotally attached to the frame intermediate the first and second ends;
a control member having a first end including a roller to ride on the actuator surface and a second end to receive a connecting rod from a device to be controlled by the assembly, the control member being pivotally attached to the frame intermediate the first and second ends; and
biasing means to bias the roller into engagement with the actuator surface.

3. The assembly as claimed in claim 2 wherein the control surface is a foot pedal.

4. The assembly of claim 2 wherein the actuator surface is shaped such that the stroke ratio increases over a first portion of the stroke of the pedal arm and the stroke ratio is substantially constant over a second portion of the stroke of the pedal arm.

5. The assembly of claim 2 wherein the actuator surface is shaped such that the stroke ratio increases over a first portion of the stroke of the pedal arm and the stroke ratio is decreases over a second portion of the stroke of the pedal arm.

6. The assembly of claim 2 wherein the actuator surface is shaped such that the stroke ratio decreases over a first portion of the stroke of the pedal arm and the stroke ratio is substantially constant over a second portion of the stroke of the pedal arm.

7. The assembly of claim 2 wherein the actuator surface is shaped such that the stroke ratio decreases over a first portion of the stroke of the pedal arm and the stroke ratio increases over a second portion of the stroke of the pedal arm.
